(19) United States
(12) Patent Application Publication
(10) Pub. No.: US 2019/0236274 A1
(43) Pub. Date: Aug. 1, 2019

(54) DETECTION OF AND RECOVERY FROM RANSOMWARE IN BACKUP DATA

(71) Applicant: EMC IP Holding Company LLC, Hopkinton, MA (US)

(72) Inventor: Adam Brenner, Lake Forest, CA (US)

(21) Appl. No.: 15/885,740

(22) Filed: Jan. 31, 2018

(51) Int. Cl. G06F 21/56; G06F 11/14; G06F 17/30

(52) U.S. Cl. CPC G06F 21/566; G06F 11/1451; G06F 2201/825; G06F 2221/034; G06F 17/30106

(57) ABSTRACT

Systems, methods, and computer-readable media can present improved detection of ransomware in a computer system. Embodiments can provide receiving backup data from the computer system. Metadata may be extracted from the backup data. Change rates of the backup metadata against prior backup data may be computed. Ransomware may be then detected by determining that the change rate exceeds a threshold change rate.

### BACKGROUND

The present disclosure relates to detecting when backup data may have been compromised by ransomware by examining backup data characteristics including backup metadata, and recovery from such scenarios.

Ransomware can comprise a variety of malware that prevents or limits access to a computer system, by for example locking access to the system, limiting access to the system's files, or otherwise limiting computer system functionality, unless a ransom is paid to restore access.

Once a system is compromised with ransomware, the data on it may be inaccessible as it may be encrypted or otherwise locked until a ransom is paid. Similarly, the files may be compromised with ransomware to be spread to other computers in a network. These files and data should not be backed up, but ways for detecting ransomware within backup data or files and restoring valid data and files are needed.

There is a need, therefore, for an improved method, article of manufacture, and apparatus for detection of ransomware in data backups and restoration of valid data.

### BRIEF SUMMARY

Embodiments can improve data storage processes and security by detecting and recovering from situations where ransomware is present in backup data.

Other embodiments are directed to systems, portable consumer devices, and computer readable media associated with methods described herein.

A better understanding of the nature and advantages of embodiments may be gained with reference to this detailed description and the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of an architecture for detecting ransomware in backup data, in accordance with some embodiments of the present disclosure.

FIG. 2 is a flowchart of a method for detecting ransomware in backup data in accordance with some embodiments of the present disclosure.

FIG. 3 is a block diagram of components for detecting ransomware in backup data in accordance with some embodiments of the present disclosure.

FIG. 4 is a block diagram of components for detecting ransomware in backup data in accordance with some embodiments of the present disclosure.

FIG. 5 is a block diagram of components for detecting ransomware in backup data in accordance with some embodiments of the present disclosure.

FIG. 6 is a block diagram of components for detecting ransomware in backup data in accordance with some embodiments of the present disclosure.

FIG. 7 is a block diagram of an example computer system 700 usable with system and methods according to various embodiments.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

An embodiment of the invention will be described with reference to a backup server, but it should be understood that the principles of the invention are not limited to this configuration. The solutions to these problems provided by some embodiments may be applied to multiple different types of data server systems, and certain examples in this application can use Dell EMC Avamar, NetWorker, Isilon, Data Protection Search, and/or Isolated Recovery systems and servers in particular, as examples for the purposes of illustration and description. It is not intended to be exhaustive or to limit embodiments to the precise form described, an embodiment can be applied to other systems.

The present disclosure discusses systems, methods and processes for detection of ransomware that may compromise system data and files, by examining backup file data characteristics including backup metadata, and recovery from such scenarios.

Ransomware can be appear on computer systems through a variety of mechanisms. For example, when users visit malicious or compromised websites. Ransomware can also arrive at a computer system attached to other malware, or be downloaded by other malware. Ransomware can also be delivered as an attachment to an email, downloaded from malicious pages, or dropped by exploit kits onto vulnerable computer systems.

When ransomware is present on a computer system, its presence can alter several attributes, signatures, and characteristics of files present on the computer system. By examining these files and their metadata against expected attributes, signatures and characteristics, it may be determined that there is likely a presence of ransomware on a computer system, and corrective actions may be taken to remove the ransomware from an infected machine.

The presence of ransomware on a computer system can be highly correlated with unexpected changes in file attributes, signatures, and characteristics on the computer system. When ransomware attacks a computer system, file change rates can increase dramatically compared to previous or expected values. In many cases, the file change rates between backups are steady or vary by only a few percent for a particular file size or an overall backup size. When ransomware attacks a computer system, the ransomware may make inaccessible one or more files, by for example encrypting one or more files with a password known to the attacker. This encryption of one or more files may increase or decrease the expected file size for one or more files that are backed up by a backup system. The ransomware may also change other attributes of one or more files to unexpected values. For example, a file could have a different modification date and time, different read/write attributes, different ownership and security attributes, or other changes to files or file systems.

File sizes and other file attributes may not change much if at all from one backup to the next. This is particularly true for certain binaries, drivers, and operating system files, which may rarely, if ever change. Ransomware may often choose to attack these binaries, drivers, and operating system files, making them inaccessible to a user of the system, and making the user of an infected machine decide whether to pay a ransom to make the files accessible again. Ransomware can also attack and make other files inaccessible. Other files, for example spreadsheets, designs, software code in development, licensing agreements, etc. can be just as valuable to an attacker and to a computer system owner, and can make an ideal target for ransomware. For these other files, under normal circumstances, there may be more expected change in size and other attributes which can be considered in the determination of whether there is likely ransomware on a computer system. These file attributes and other backup data can be considered as part of the backup metadata.

Backup metadata can include for example: the amount of data changed compared to one or more prior backups, new bytes of data saved, filesystem metadata such as file names, file size, full path, and modification time. Backup metadata can be typically stored within a backup system such Dell EMC's Avamar or Networker systems, or other backup systems. Some of the metadata might be available within associated backup search systems, within a data deduplication system, or with a disaster recovery system.

If a computer system has been backed up previously, the change rate in file size between current version of files in a backup and one or more prior versions can be compared to see if the change in size is in an expected range. Additionally, overall backup size can be compared to expected values. File attributes can be compared to their expected values. The system may also check to see if new files are present in a current backup and/or others unexpectedly not present in the current backup.

Alternatively or additionally, file attributes in a backup can be compared to expected file attributes based on a machine profile. Based on computer system type, a profile of expected file attributes can be created and used for comparison. Profiles can be created for example based on machine type: e.g. server, desktop, laptop, mobile device, virtual machine, NAS; operating system: e.g. Linux, Mac OS, Windows, iOS, Android; employee type: e.g. engineering, accounting, executive, administrative. These examples should not be considered to be limiting of the possible profile types, but are meant as examples for illustration purposes. File sizes and other attributes in a backup can thus be compared against one or more profiles for a machine type, employee type, or other categorization for a machine or machine user. The sizes and other attributes may comprise file metadata.

If no ransomware is detected in a set of backup data by analyzing the file metadata, the backup data may be added to existing backup data for a particular machine, and stored as normal. The backup data may also be added to or used to adjust one or more profiles

If it is determined that there is potentially ransomware in a set of backup data from a potentially infected computer system, the backup system may take several actions. The backup system may alert an administrator or other responsible party that there is likely ransomware on potentially infected computer system that the backup data came from. That potentially infected computer system may be disconnected from other computer systems on the network that it is connected to, so that the ransomware is not spread to other computer systems in the network. The potentially infected computer system may also be rolled back to a last known good state. The backup system may find the last known good state of data for the potentially infected computer system by finding a valid backup for the potentially infected computer system. The backup system may send data to be restored to the potentially infected computer system.

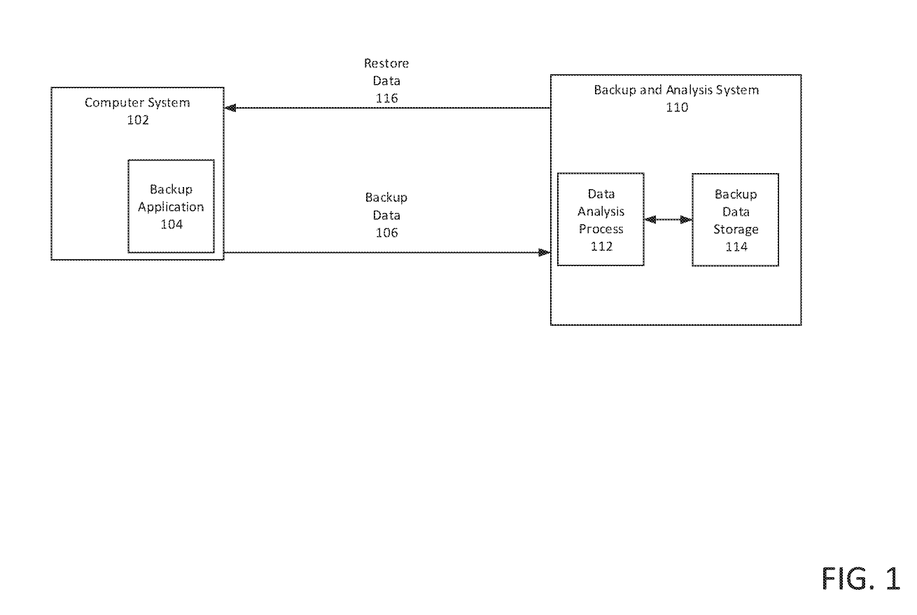

FIG. 1 is a block diagram of an architecture for detecting ransomware in backup data, in accordance with some embodiments of the present disclosure. In the example shown, computer system 102 has a backup application 104. Backup application 104 may collect files and data to back up at set times or on demand. These files and data, backup data 106 can then be sent to a system for analyzing backup data to determine whether there is potentially any ransomware contained in the backup data, such as backup and analysis system 110.

Backup and analysis system 110 may receive backup data 106, and use data analysis process 112 to analyze backup data 106 to determine whether there is potentially any ransomware contained in the backup data 106. Data analysis process 112 may request and receive data from backup data storage 114. This data received can relate to computer system 102, and can include expected backup file data characteristics including backup file metadata such as information on expected file sizes, permissions, and modification dates. This expected backup file data may comprise data from prior backups of computer system 102 and/or data based from profiles of similar machine types as computer system 102 or user types of computer system 120.

Backup and data analysis system 110 may determine there is a likelihood of ransomware in the backup data 106 if the metadata of backup data 106 unexpectedly differs from prior metadata for computer system 102 or a similar system. As a result of this determination, one or more alerts may be raised. These alerts may comprise alerts to system operators in the form of email, SMS text, computer pop-up message, or similar alert to one or more system operators.

It may be determined that computer system 102 is infected with ransomware, and that the computer system 102 needs to be restored to a state prior to ransomware being detected. The system may determine which files have potentially been infected by ransomware, and replace them with known, valid versions. Backup data storage 114 may be queried for such versions, which can comprise earlier backup data from computer system 102 stored at backup data storage 114 and/or data and files from similar machines. Restore data 116 may be sent to computer system 102 to replace files at computer system 102 that potentially are infected with ransomware.

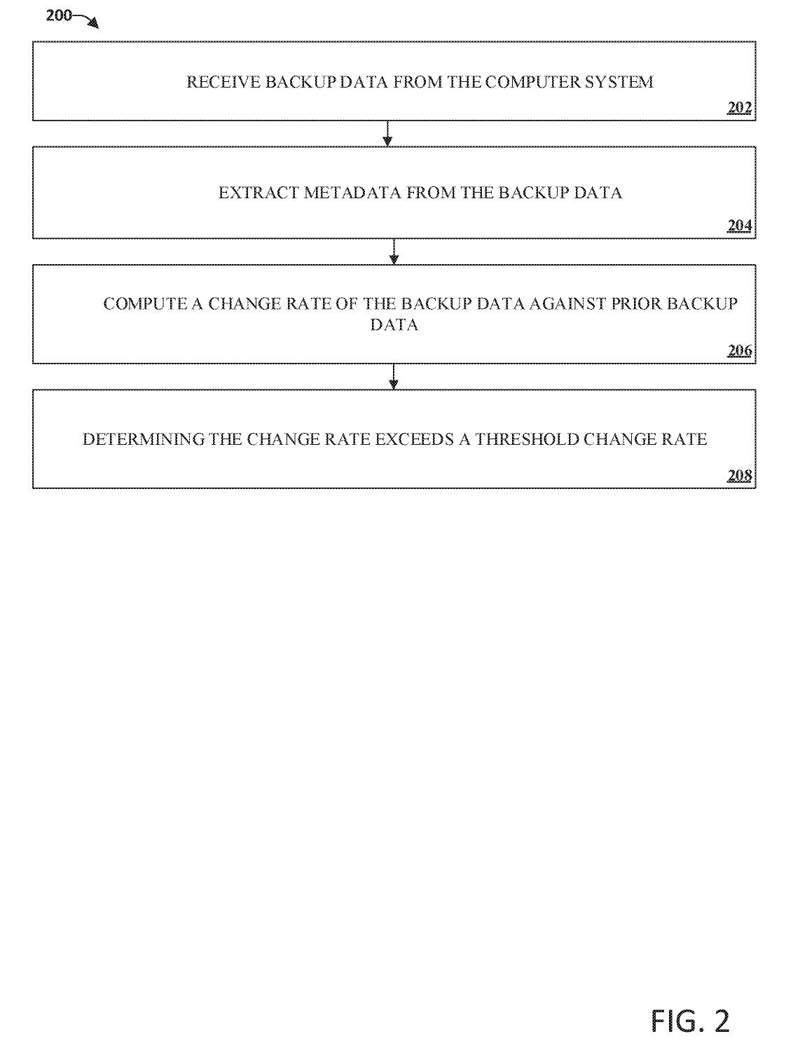

FIG. 2 is a flowchart of a method 200 for detecting ransomware in a computer system in accordance with some embodiments of the present disclosure. Method 200 may be implemented by elements of computer system 102 using backup application 104, in communication with backup and analysis system 110, and may use data analysis process 112 and may retrieve and store data in backup data storage 114. The functionality of backup and analysis system 110 may be provided for in the alternative by backup server 310, search server 410, isolated data vault 510 and/or backup server 610 and isolated data vault 630.

The method may occur on one or more devices. The backup application may be a standalone application or it may be an application integrated with another program on a computer system. Backup and analysis system similarly may comprise one or more computing devices.

At block 202, backup data may be received from a computer system. The computer system may collect data to be backed up, which may include data and files of various types, including but not limited to binaries, drivers, operating system files, spreadsheets, designs, software code in development, and other documents. A backup application may be used to collect such backup data and files. The backup data collection may occur at scheduled times or ad hoc. The files collected from the computer system may be sent immediately after collection, or may be sent at specified times.

At block 204, metadata is extracted from the backup data. This metadata can contain information about the files to be backed up. It can contain information, for example the size of the backup as a whole, when the backup occurred, the size of each file, who last edited each file, when each file was last modified, the type of machine from which the backup data came from, information about a user of the machine from which the backup data came from. The metadata may contain other information regarding backup policies and other computer environmental factors regarding the backup data and the computer system it came from.

At block 206, a change rate of the backup data can be computed against prior backup data, for example prior backup metadata stored at a backup device or service. A backup and data analysis system, such as system 110 can access a variety of information regarding past and expected backup data characteristics.

For example, a backup and data analysis system can calculate the expected size of each backup file in the backup data based on prior backup data size, and compare the expected and current size. The system can compare expected file permissions against prior values received from the same machine. The system can compare individual metadata such as file sizes and other file characteristics against expected values.

A backup and data analysis system can calculate the expected size of each backup file in the backup data based on an expected profile for a machine type or user type, and compare the expected and current size. The backup and data analysis system may have access to profiles for particular user and system types that are comprised of data from multiple machines and users that are of the same type as the user of the backup data, and/or of the machine type of the computer system. The backup and data analysis system can compare expected file data against prior values received from similar machine and/or user types. This comparison can produce one or more change rates for the backup data against prior backup data. There can be change rates calculated for various characteristics of each file or piece of data in the backup data, for the backup as a whole, and for various other combinations of characteristics of the backup data.

At block 208, it is determined whether one or more of the change rates exceeds a threshold change rate. If so, there may be ransomware present in the backup data received from the computer system. If not, then the backup data may be free from ransomware.

If it is determined that one or more of the change rates exceeds a threshold change rate, an alert may be sent to and administrator or other responsible party that there is likely ransomware on potentially infected computer system that the backup data came from. Additional potential actions include disconnecting the potentially infected computer system from other computer systems on a network that it is connected to, to potentially stop ransomware spreading to other computer systems in the network. The potentially infected computer system may also be rolled back to a last known good state. The backup system may find the last known good state of data for the potentially infected computer system by finding a valid backup for the potentially infected computer system.

The system may also save the current backup data and update the prior backup data with additional samples. It may also update profiles built up for corresponding file, user, and machine types. The current metadata information in the backup data thus may be incorporated into prior backup data and used to update relevant profiles of user and machine types. If the change rate does exceed a threshold change rate, the backup and data analysis system may choose not to incorporate all or some of this current metadata, as it is likely indicative of ransomware, and could be not suitable for use in future comparisons of extracted metadata.

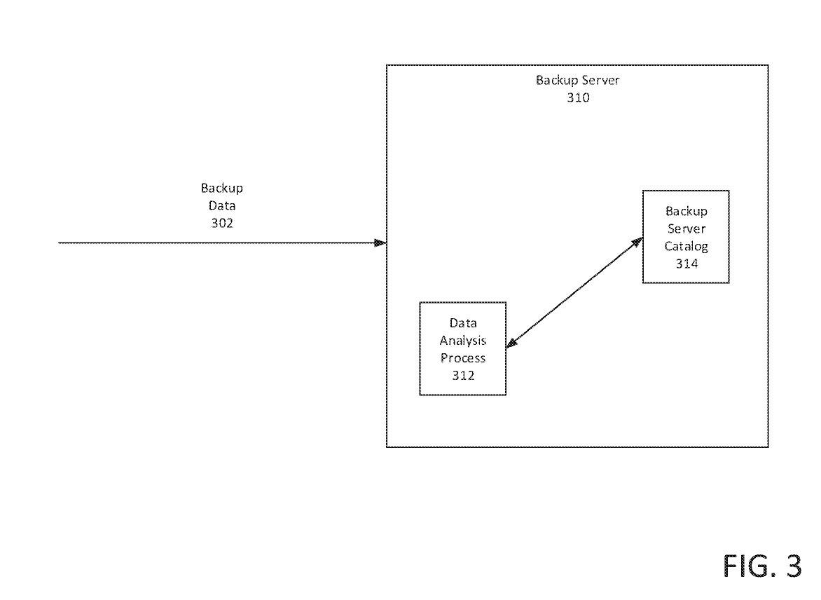

FIG. 3 is a block diagram of components for detecting ransomware in backup data in accordance with some embodiments of the present disclosure. Backup server 310 can provide the functionality of backup and analysis server 110. Backup server 310 for example, can comprise a Dell EMC Avamar or Networker server, and can use existing backup metadata from Avamar or Networker to detect potential ransomware. Data analysis process 312 can process backup data 302, comparing it to known profiles for similar machines or users, or comparing it to prior data for the computer system from which backup data 302 came from. Results of the comparison can be saved within backup server catalog 314. Backup server catalog 314 may also be queried for known profiles for similar machines or users, and/or prior data for the computer system from which backup data 302 came from.

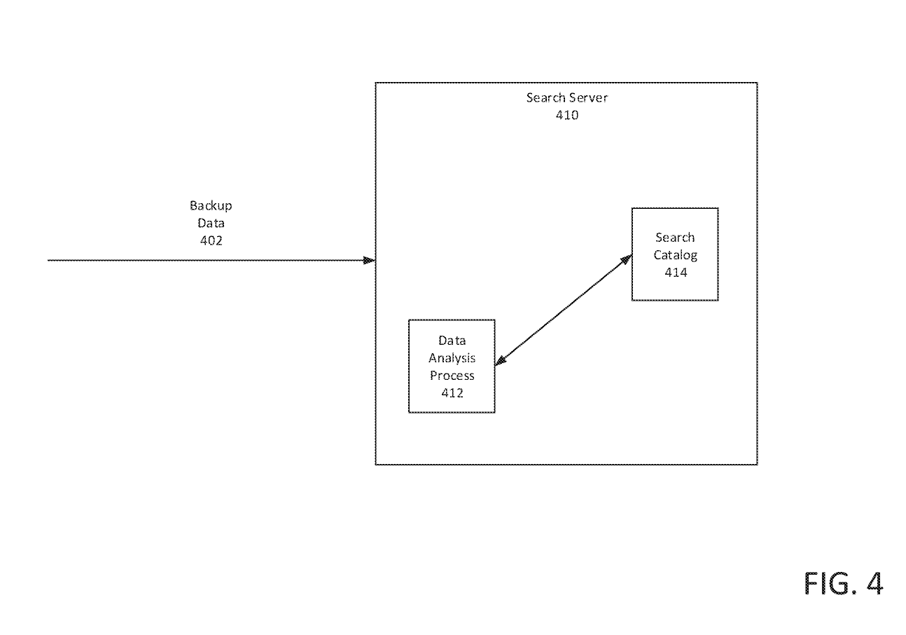

FIG. 4 is a block diagram of components for detecting ransomware in backup data in accordance with some embodiments of the present disclosure. Search server 410 can provide the functionality of backup and analysis server 110. Search server 410 for example, can comprise a Dell EMC DPSearch server, and can use existing backup metadata from an indexing service and collector service to detect potential ransomware. Data analysis process 412 can process backup data 402, comparing it to known profiles for similar machines or users, or comparing it to prior data for the computer system from which backup data 402 came from. Results of the comparison can be saved within search server 410, for example within backup search catalog 414. Search catalog 414 may also be queried for known profiles for similar machines or users, and/or prior data for the computer system from which backup data 402 came from.

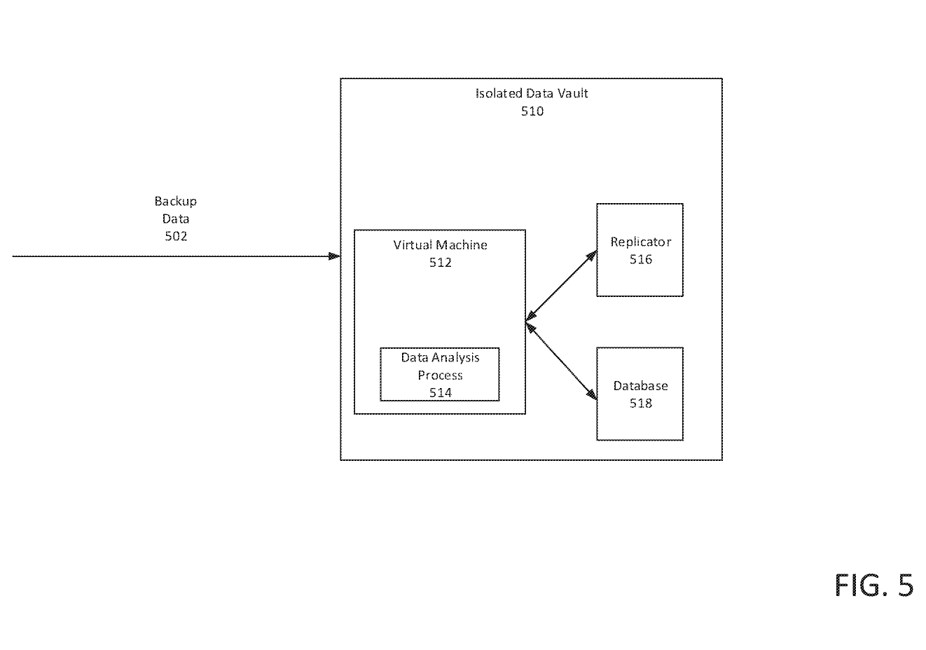

FIG. 5 is a block diagram of components for detecting ransomware in backup data in accordance with some embodiments of the present disclosure. Isolated data vault 510 can provide the functionality of backup and analysis server 110, with additional separation and isolation from a main network, which may provide additional protection from ransomware propagation across a network. Isolated data vault 510 can comprise for example, a Dell EMC Isolated Recovery vault, for example, and can further include a virtual machine, such as virtual machine 512 to perform comparison of data and files to detect potential ransomware, by comparing existing backup metadata from for example database 518 to detect potential ransomware.

Replicator 516, can be used to provide encrypted data replication for further analysis of backup data 502. For example, it may comprise a Dell EMC Data Domain Replicator. Data analysis process 514 can process backup data 502, comparing it to known profiles for similar machines or users, or comparing it to prior data for the computer system from which backup data 502 came from. Data analysis process 514 can use replicator 516 to determine change rate of a particular file in the backup data or overall backup size or other characteristics. If a percent change of data in backup data is exceeds a certain threshold, the backup data may be marked as suspicious, otherwise, backup data may be marked as not suspicious for ransomware.

Results of the comparison can be saved within database 518. Database 518 may also be queried for known profiles for similar machines or users, and/or prior data for the computer system from which backup data 502 came from. Database 518 may for example comprise an Isolated Recovery database.

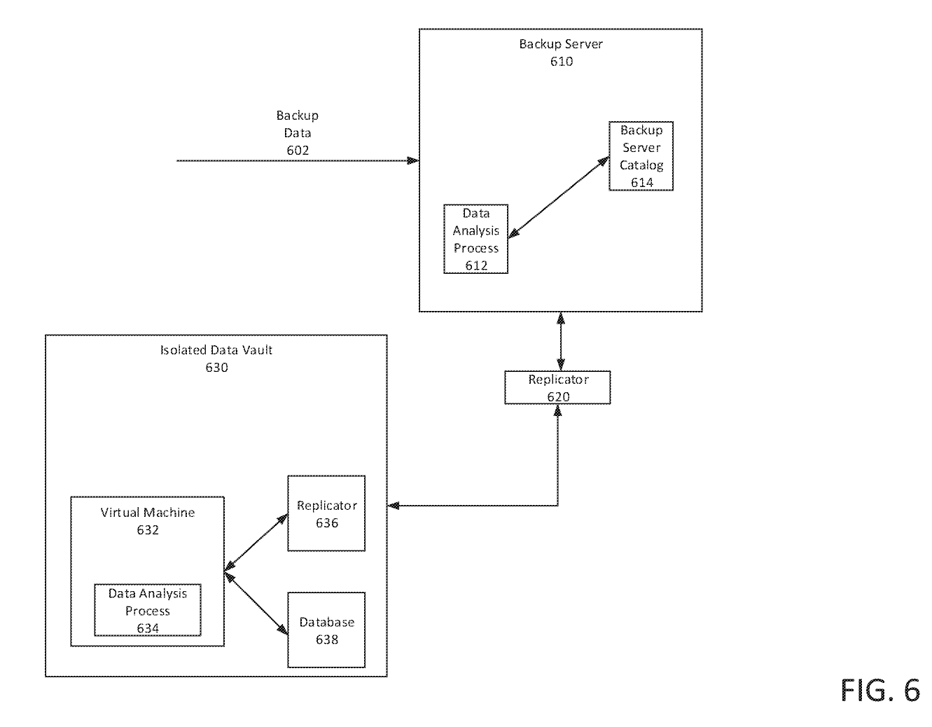

FIG. 6 is a block diagram of components for detecting ransomware in backup data in accordance with some embodiments of the present disclosure. Backup server 610 can provide the functionality of backup and analysis server 110. Backup server 610 can comprise for example, a Dell EMC Avamar or Networker server, and can use existing backup metadata from Avamar or Networker to detect potential ransomware. Data analysis process 612 can process backup data 602, comparing it to known profiles for similar machines or users, or comparing it to prior data for the computer system from which backup data 602 came from. Results of the comparison can be saved within backup server catalog 614. Backup server catalog 614 may also be queried for known profiles for similar machines or users, and/or prior data for the computer system from which backup data 602 came from.

In addition, backup server 610 may use an isolated data system for analysis of backup data 602. Using a data replicator 620, backup server 610 can send backup data 602 to isolated data vault 630, which can also provide the functionality of backup and analysis server 110, with additional separation and isolation from a main network, which may provide additional protection from ransomware propagation across a network. Isolated data vault 630 can comprise for example, a Dell EMC Isolated Recovery vault, for example, and can further include a virtual machine, such as virtual machine 632 to perform comparison of data and files to detect potential ransomware, by comparing existing backup metadata from for example database 638 to detect potential ransomware.

Replicator 636, can be used to provide encrypted data replication for further analysis of backup data 602. For example, it may comprise a Dell EMC Data Domain Replicator. Data analysis process 634 can process backup data 602, comparing it to known profiles for similar machines or users, or comparing it to prior data for the computer system from which backup data 602 came from. Data analysis process 634 can use replicator 636 to determine change rate of a particular file in the backup data or overall backup size or other characteristics. If a percent change of data in backup data is exceeds a certain threshold, the backup data may be marked as suspicious, otherwise, backup data may be marked as not suspicious for ransomware.

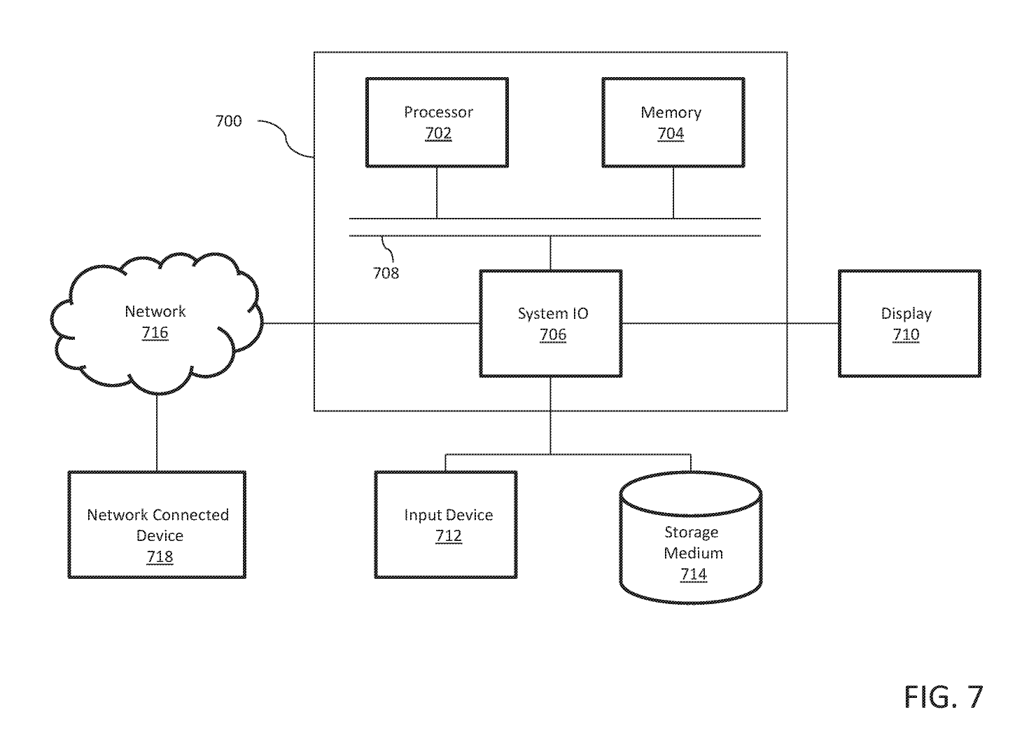

FIG. 7 depicts a computer system which may be used to implement different embodiments discussed herein. General purpose computer 700 may include processor 702, memory 704, and system 10 controller 706, all of which may be in communication over system bus 708. In an embodiment, processor 702 may be a central processing unit (“CPU”) or accelerated processing unit (“APU”). Some embodiments may comprise multiple processors, or a processor with multiple cores. Processor 702 and memory 704 may together execute a computer process, such as the processes described herein.

System IO controller 706 may be in communication with display 710, input device 712, non-transitory computer readable storage medium 714, and/or network 716. Display 710 may be any computer display, such as a monitor, a smart phone screen, or wearable electronics and/or it may be an input device such as a touch screen. Input device 712 may be a keyboard, mouse, track-pad, camera, microphone, or the like, and storage medium 714 may comprise a hard drive, flash drive, solid state drive, magnetic tape, magnetic disk, optical disk, or any other computer readable and/or writable medium.

Network 716 may be any computer network, such as a local area network (“LAN”), wide area network (“WAN”) such as the internet, a corporate intranet, a metropolitan area network (“MAN”), a storage area network (“SAN”), a cellular network, a personal area network (PAN), or any combination thereof. Further, network 716 may be either wired or wireless or any combination thereof, and may provide input to or receive output from IO controller 706. In an embodiment, network 716 may be in communication with one or more network connected devices 718, such as another general purpose computer, smart phone, PDA, storage device, tablet computer, or any other device capable of connecting to a network.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The disclosed embodiments are illustrative and not restrictive, and the invention is not to be limited to the details given herein. There are many alternative ways of implementing the invention. It is therefore intended that the disclosure and following claims be interpreted as covering all such alterations and modifications as fall within the true spirit and scope of the invention.

What is claimed is:

1. A computer-implemented method for detecting ransomware in a computer system, the method comprising:
receiving backup data from the computer system;
extracting metadata from the backup data;
computing a change rate of the metadata against prior backup data; and
determining the change rate exceeds a threshold change rate.

2. The method of claim 1, wherein the prior backup data comprises data from prior backups of the computer system.

3. The method of claim 1, wherein the prior backup data comprises data from prior backups of similar computer systems to the computer system.

4. The method of claim 1, wherein computing the change rate comprises determining whether a file permission has changed.

5. The method of claim 1, wherein computing the change rate comprises determining whether a file size has changed.

6. The method of claim 1, wherein computing the change rate comprises determining whether a file modification date has changed.

7. The method of claim 1, further comprising determining a file in the backup data contains ransomware and sending a prior version of the file to the computer system.

8. The method of claim 1, further comprising raising an alert regarding the computer system.

9. A computer program product for detecting ransomware in a computer system, the method comprising:
receiving backup data from the computer system;
extracting metadata from the backup data;
computing a change rate of the metadata against prior backup data; and
determining the change rate exceeds a threshold change rate.

10. The computer program product of claim 9, wherein the prior backup data comprises data from prior backups of similar computer systems to the computer system.

11. The computer program product of claim 9, wherein computing the change rate comprises determining whether a file size has changed.

12. The computer program product of claim 9, further comprising determining a file in the backup data contains ransomware and sending a prior version of the file to the computer system.

13. A system for backup of a data server comprising a non-transitory computer readable medium and a processor configured to:
receive backup data from the computer system;
extract metadata from the backup data;
compute a change rate of the metadata against prior backup data; and
determine the change rate exceeds a threshold change rate.

14. The system of claim 13, wherein the prior backup data comprises data from prior backups of the computer system.

15. The system of claim 13, wherein the prior backup data comprises data from prior backups of similar computer systems to the computer system.

16. The system of claim 13, wherein computing the change rate comprises determining whether a file permission has changed.

17. The system of claim 13, wherein computing the change rate comprises determining whether a file size have changed.

18. The system of claim 13, wherein computing the change rate comprises determining whether a file modification date has changed.

19. The system of claim 13, further configured to determine a file in the backup data contains ransomware and sending a prior version of the file to the computer system.

20. The system of claim 13, further configured to raise an alert regarding the computer system.
